(19) United States
(12) Patent Application Publication
(10) Pub. No.: US 2009/0011138 A1
(43) Pub. Date: Jan. 8, 2009

(54) ANTIQUE BLIND SLAT FABRICATION METHOD

(75) Inventor: Po-Yu Chen, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Chin-Fu Chen, Taichung (TW)

(21) Appl. No.: 11/938,911

(22) Filed: Nov. 13, 2007

(30) Foreign Application Priority Data
Jul. 5, 2007 (TW) 96124546

(51) Int. Cl. B05D 3/00

(52) U.S. Cl. 427/532

(57) ABSTRACT

An antique blind slat fabrication method Includes the steps of a) preparing a slat substrate subject to a predetermined size, b) coating a surface of the slat substrate with a base coat, c) grinding the base-coated surface of the slat substrate, and d) coating the base coat with a wood grain paint.

### BACKGROUND OF THE INVENTION

1. Field of the Invention

The present invention relates generally to a method of making blind slats for window covering and more particularly, to a method of fabricating antique blind slats.

2. Description of the Related Art

In order to hide from sight, to block unwanted heat of the sun, or to reduce light to varying degrees, a window blind may be used and attached to the interior side of a window. A regular window blind is comprised o f a set of blind slats prepared from wood, plastics, aluminum alloy, etc. A blind slat made of aluminum alloy has lightweight and fireproof characteristics. However, the monotonous outer appearance of aluminum alloy blind slats cannot attract people's eyes. Therefore, manufacturers may use transfer printing technique to cover the surface of an aluminum allow blind slat with a design or grain pattern, giving a visual effect. However, this coast tends to reflect light, causing the design or grain pattern not easy to be seen and lowering the sense of beauty of the outer appearance of the blind slat.

### SUMMARY OF THE INVENTION

The present invention has been accomplished under the circumstances in view. It is the primary objective of the present invention to provide an antique blind slat fabrication method, which is practical for the fabrication of blind slats that have an antique sense of beauty.

To achieve this objective of the present invention, the antique blind slat fabrication method provided by the present invention comprises the steps of a) preparing a slat substrate, b) coating a surface of the slat substrate with a base coat, c) grinding the base-coated surface of the slat substrate, and d) coating the base coat with a first layer of wood grain paint.

In an exemplary embodiment to be detailed described hereinafter, the method further includes a step of forming pits on the base-coated surface of the slat substrate for simulating a wormhole effect on the slat substrate. In addition, a color shading treatment on the base-coated surface of the slat substrate after formation of the pits can be performed. Further, a color shading treatment on the first layer of wood grain paint can be performed. A step of coating a second layer of wood grain paint on the first layer of wood grain paint can be further performed. Finally, a layer of gloss finish can be further coated on the second layer of wood grain paint.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a processing flow chart of the antique blind slat fabrication method in accordance with an exemplary embodiment of the present invention;

FIG. 2 is a schematic sectional drawing showing a slat substrate;

FIG. 3 is a schematic sectional drawing showing that a base coat is coated on the surface of the slat substrate;

FIG. 4 is a schematic sectional drawing showing that pits are formed on the base coat-coated surface of the slat substrate;

FIG. 5 is a schematic sectional drawing showing that a first wood grain paint is coated on the base coat-coated surface of the slat substrate;

FIG. 6 is a schematic sectional drawing showing that a second wood grain paint and a layer of gloss finish are orderly coated on the surface of the first wood grain paint, and

FIG. 7 is a perspective view of a part of an antique blind slat made according to the method of the present invention.

### DETAILED DESCRIPTION OF THE INVENTION

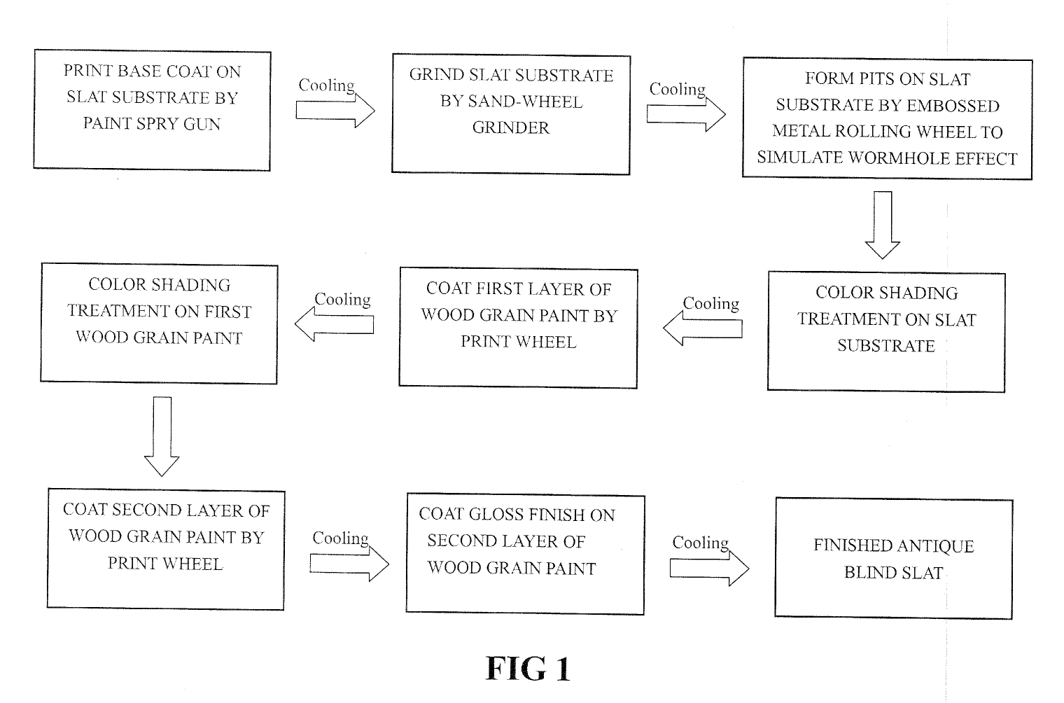

As shown in FIGS. 1-6, an antique blind slat fabrication method in accordance with an exemplary embodiment of the present invention comprises the following steps.

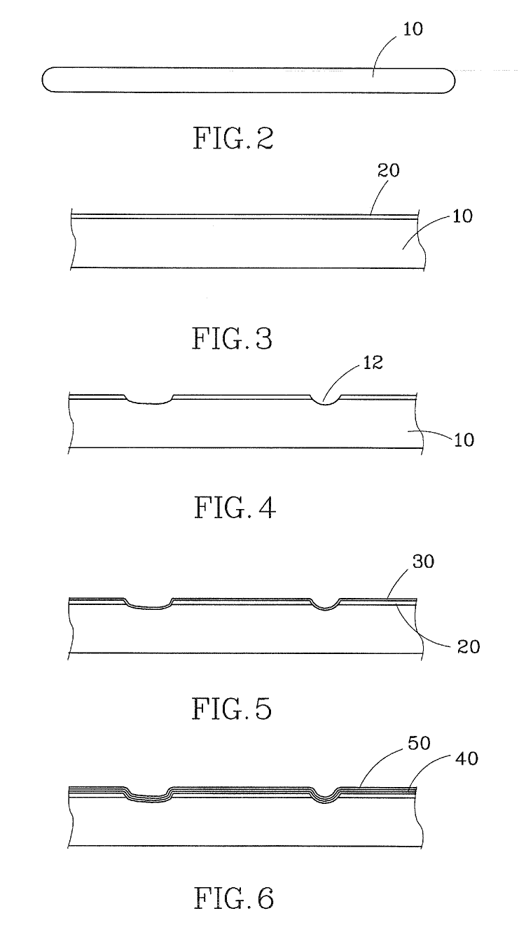

(a) Prepare a slat substrate 10 from wood or plastics subject to a predetermined thickness and width as shown in FIG. 2, and then put the slat substrate 10 in a conveyer (not shown), which delivers the slat substrate 110 stably forwards at a controlled speed.

(b) Use a pneumatic paint spray gun (not shown) to spray a layer of base coat 20 on the surface of the slat substrate 10 as shown in FIG. 3, and then dry the base coat 20 with cooling fans.

(c) Use a sand-wheel grinder (not shown) to grind the surface of the base coat 20 of the slat substrate 10, causing the surface of the base coat 20 of the slat substrate 10 to show an old wood effect.

(d) Use an embossed metal rolling wheel (not shown) to process the base coat 20 of the slat substrate 10, forming pits 12 on the surface of the slat substrate 10 to simulate a wormhole effect on the slat substrate 10, and then treating the surface of the slat substrate 10 with a color shading treatment by using three print wheels (not shown) with a mixture of colorant and varnish, as shown in FIG. 4.

(e) Use two printing wheels (not shown) to print a first layer of wood grain paint 30 on the surface of the base coat-coated slat substrate 10 as shown in FIG. 5, and then dry the first layer of wood grain paint 30 with cooling fans, and then perform a color shading treatment by using a print wheel (not shown) with colorant on the first wood grain paint 30 so that the surface of the slat substrate 10 shows an antique sense of beauty

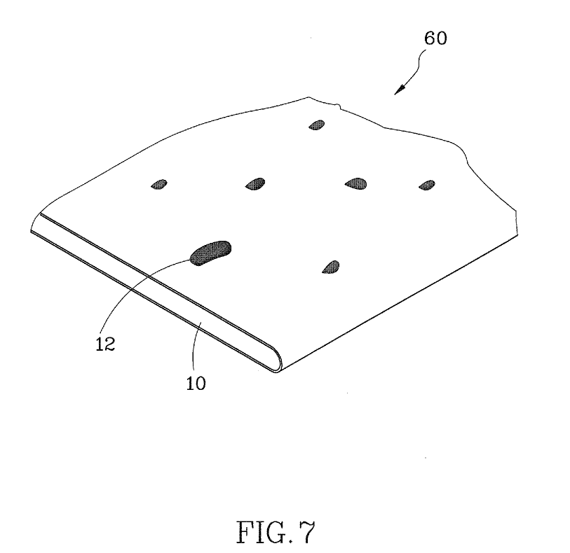

(f) Use a print wheel (not shown) to print a second layer of wood grain paint 40 on the surface of the first layer of wood grain paint 30, and then dry the second layer of wood grain paint 40 with cooling fans. Thereafter, use a print wheel (not shown) to print a layer of gloss finish 50 on the surface of the second layer of wood grain paint 40 to enhance the surface quality of the slat substrate 10 and to protect the surface of the slat substrate 10 as shown in FIG. 6, and then dry the gloss finish 50 with cooling fans, so as to obtain a finished antique blind slat 60 as shown in FIG. 7.

As stated above, the invention has the following features and advantages:

1. The surface of the slat substrate is coated with two layers of wood grain paint, showing an antique sense of beauty and improving the quality of the product.

2. The surface of the slat substrate has pits simulating wormholes, showing a unique sense of beauty.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An antique blind slat fabrication method comprising the steps of:
a) preparing a slat substrate;
b) coating a surface of the slat substrate with a base coat;
c) grinding the base-coated surface of the slat substrate; and
d) coating the base coat with a first layer of wood grain paint.

2. The antique blind slat fabrication method as claimed in claim 1, further comprising a step of forming pits on the base-coated surface of the slat substrate after step c) and before step d).

3. The antique blind slat fabrication method as claimed in claim 2, wherein the step of forming pits on the base-coated surface of the slat substrate is carried by an embossed metal rolling wheel.

4. The antique blind slat fabrication method as claimed in claim 2, further comprising a step of performing a color shading treatment on the base-coated surface of the slat substrate after formation of the pits.

5. The antique blind slat fabrication method as claimed in claim 1, further comprising a sub-step of performing a color shading treatment on the first layer of wood grain paint in step d).

6. The antique blind slat fabrication method as claimed in claim 5, further comprising a step of e) coating a second layer of wood grain paint on the first layer of wood grain paint.

7. The antique blind slat fabrication method as claimed in claim 6, further comprising a step of f) coating on the second layer of wood grain paint with a layer of gloss finish.

8. The antique blind slat fabrication method as claimed in claim 1, wherein the slat substrate prepared in step a) is made by wood.

9. The antique blind slat fabrication method as claimed in claim 1, wherein the step c) of grinding the base-coated surface of the slat substrate is carried by a sand-wheel grinder.
